(19) United States
(12) Patent Application Publication
(10) Pub. No.: US 2011/0162176 A1
(43) Pub. Date: Jul. 7, 2011

(54) Ball-type clevis pin

(76) Inventors: Timothy T. Tylaska, Preston, CT (US); Thomas W. Dixon, New London, CT (US)

(21) Appl. No.: 12/930,338

(22) Filed: Jan. 4, 2011

Related U.S. Application Data
(60) Provisional application No. 61/335,261, filed on Jan. 4, 2010.

(51) Int. Cl. F16C 11/00

(52) U.S. Cl. 24/595.1

(57) ABSTRACT

A ball-type locking clevis pin having substantially the same overall dimensions and profiles as a standard clevis pin but without the snagging characteristics of cotter pins or rings used on typical clevis pins. The pin has a low profile flanged head of substantially the same dimensions as the head of a typical clevis pin. This low profile head greatly reduces the snagging tendencies of the large heads inherent with typical ball lock pins and the locking balls on the opposite end of the pin eliminate the snagging tendencies of cotter pins used on conventional clevis pins. A release button is located flush or recessed inside the flanged head so that it is not exposed to bumping and accidental release from external impacts. The pin consists of a hollow tube flanged on one end and of substantially the same dimensions as a standard clevis pin. The tube is bored from each end with a short internal section bored to a slightly smaller diameter in a location between the two ends. One or more detent balls are located radially around the outside diameter of the tube opposite the flanged end. An internal shaft slides inside the axial internal bore of the tube. The internal shaft contains a beveled diameter transition at one end to ramp the balls radially outward. The internal shaft slides through a spring and is then attached to a larger diameter cylinder which acts to retain the spring. The spring exerts force on the axial face of this larger diameter cylinder and also on the axial face of the smaller diameter bored section of the tube. The larger diameter cylinder acts as a release button to activate the movement of the balls and allow the pin to be inserted or removed.

This application claims benefit of U.S. Provisional Patent Application No. 61/335,261, filed on Jan. 4, 2010 pursuant to 35 USC §119(e).

### FIELD OF THE INVENTION

This invention relates to fasteners for releasably holding two or more parts together, in particular, clevis pins.

### BACKGROUND OF THE INVENTION

In many applications, a pin is used to resist the shear or allow the rotation of a connected part about the axis of a bored hole in a mating part. A common name for this type of pin is the clevis pin and it is normally an off the shelf item stocked in standard length and diameter increments as shown in FIG. 1. A clevis pin 60 consists of a flanged head 62, a shank 64 and a hole 66 bored radially through the shank at the end of the pin opposite the flanged head. A cotter pin 68, a spring type ring or a wire (not shown) is generally inserted through hole 66 to prevent the clevis pin 60 from sliding axially out through the part that it is securing. Clevis pins are commonly used in turnbuckles for sailboat rigging as well as in the automotive, aircraft and construction industries.

While the typical clevis pin is very simple, it has several disadvantages. A major problem is that the exposed cotter pin 68 or spring ring used on the clevis pin is prone to snagging. This is especially true in the field of sailing. The sail or lines catch on this exposed cotter pin 68 or ring and become jammed or tear the material. The sharp edges 69 of the cotter pin 68 also create a physical hazard to the crew of the boat who must constantly walk past these exposed points. Existing solutions to this hazard consist of wrapping tape over the sharp edges of the cotter pins, but such tape quickly degrades in the wet ocean atmosphere.

Another major problem with the typical clevis pin is that the cotter pin or spring ring used to contain the pin is not easily removed. The legs 67 of the cotter pin must be bent with pliers or the spring ring must be carefully squeezed and twisted. These operations are especially difficult to perform on a sailing vessel while in rough seas. In crisis situations at sea, in some instances it is necessary to quickly remove the clevis pins from the rigging to prevent the vessel from capsizing. The use of the cotter pin or spring ring makes such quick removal difficult.

One solution to aid with the fast removal of the clevis pin is to use a quick release ball-type locking pin 70 as shown in FIG. 2. Typically called pip-pins, these ball-type locking pins 70 having a ball 74 are used predominately in the aerospace field. A major problem with these types of pins for use in the field of sailing is that the head 72 of the pin 70 is very large and bulky and prone to cause snagging. The typical pip-pin is designed so that it has a spring mechanism located in a handle or head 72, which sticks out past the end of the pin and does not have the same low profile flanged head 62 like a typical clevis pin. This makes its use almost unacceptable for the sailboat rigging application.

There is not found in the prior art, a clevis pin that overcomes the drawbacks of both the prior art clevis pin and the available ball lock type of pins.

### SUMMARY OF THE INVENTION

It is an aspect of the invention to provide a ball-type clevis pin of substantially the same dimensions and profile as a standard clevis pin, but also implement the ball lock feature of a ball-type type pin.

It is still another object of the invention to provide a ball-type clevis pin that provides a ball locking pin which has a very low profile head and no exposed features which can cause snagging on other objects.

Another aspect of the invention is to provide a ball-type clevis pin that can be removed quickly.

It is another aspect of the invention to provide a ball-type clevis pin with the same resistance to force in the axial direction as provided with a cotter pin or spring ring, but which implements a locking ball mechanism.

It is still another aspect of the invention to provide a ball-type clevis pin, which has a release button, which is flush or recessed into the head of the pin to prevent accidental release.

It is still another aspect of the invention to provide a ball-type clevis pin, which has two release buttons, one on each end, which are flush or recessed into the head of the pin to prevent accidental release and to permit releasing the pin from either end for even easier and faster release of the pin.

Another aspect of the invention is to provide a ball-type clevis pin, which can be substituted interchangeably with a prior art clevis pin of substantially the same dimensions.

Another aspect of the invention is to provide a ball-type clevis pin, which can be quickly and easily inserted and removed without the need for special tools.

Finally, it is another aspect of the invention to provide a ball-type clevis pin with substantially the same shear resistance as a prior art standard clevis pin of the same size.

The invention is a clevis pin with the same physical dimensions as a standard clevis pin but with a locking ball mechanism in place of the cotter pin. Unlike a typical ball lock pin, the invention utilizes an internal arrangement which eliminates the need for a bulky, exposed head or handle and instead utilizes a low profile flanged head of basically the same dimensions as that of a standard clevis pin. The ball pin locking mechanism and release button is located internally inside the invention and provides a direct interchangeable replacement for a standard clevis pin but with the added features of being both snag free and removable.

### BRIEF DESCRIPTION OF THE DRAWINGS

FIG. 1 is an isometric view of a typical prior art clevis pin.

FIG. 2 is an isometric view of a typical prior art ball-type clevis pin.

FIG. 3 is a cross sectional view of the ball-type clevis pin in a locked position in accordance with an alternative embodiment of the invention.

FIG. 4 is a cross sectional view of the ball-type clevis pin in an unlocked position in accordance with the alternative embodiment of the present invention.

FIG. 5 is an end view of the flanged head and releasable button.

FIG. 6 is a side view of the invention in place on a typical turnbuckle such as might be found on a sailboat.

FIG. 7 is an isometric view of the invention in place as shown in FIG. 6.

FIG. 8 is a cross sectional view of the ball-type clevis pin in a locked position in accordance with the preferred embodiment of the invention.

FIG. 9 is a cross sectional view of the preferred embodiment of the ball-type clevis pin shown in an unlocked position that has been unlocked by the left button.

FIG. 10 is a cross sectional view of the preferred embodiment of the ball-type clevis pin shown in an unlocked position that has been unlocked by the right button.

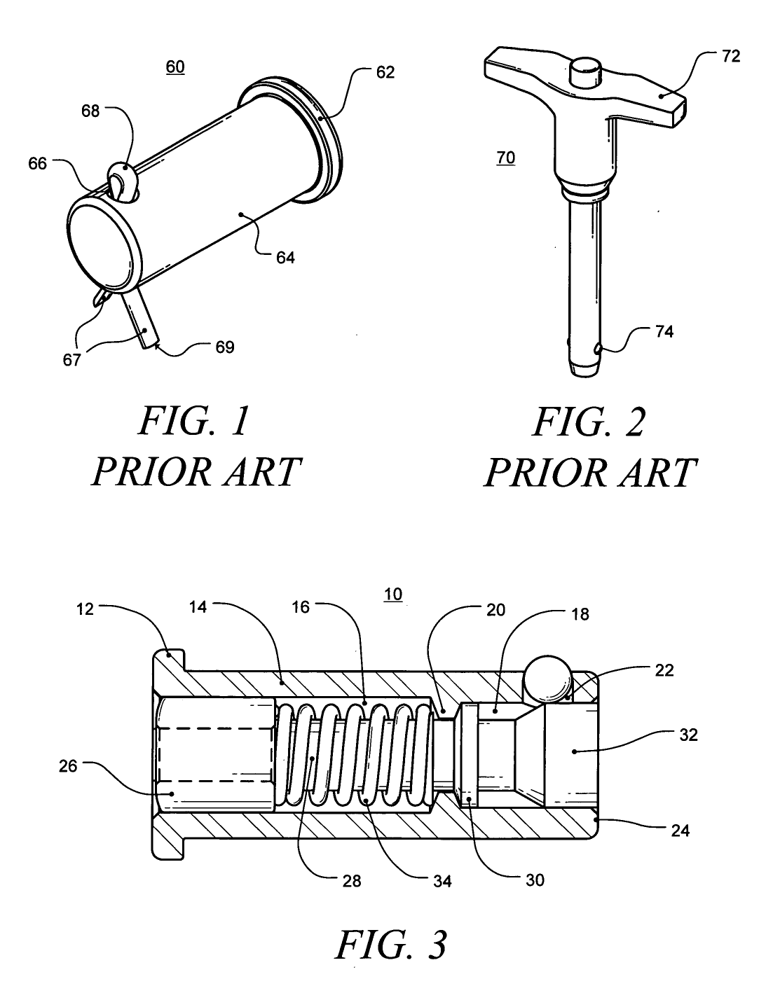

### DETAILED DESCRIPTION OF THE INVENTION

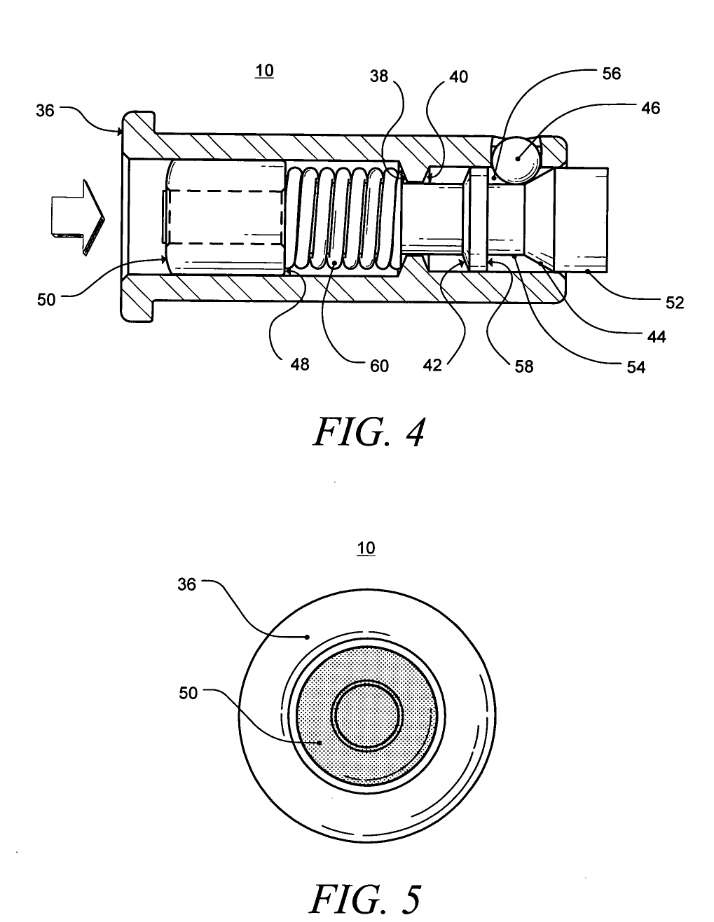

Referring now to FIGS. 3 and 4, the ball-type clevis pin 10 having a single release button 26 is illustrated. Pin 10 is intended to be utilized to lock two or more objects together in the same fashion as a standard prior art clevis pin. Pin 10 consists of a flanged-headed end 12, a shank 14, a internal axial bore 16, at least one second internal axial bore 18, an internal flange 20, a radial hole 22, a non-flanged end 24, at least one release button 26, a shaft 28, a flange 30, a shaft end 32 and at least one spring 34.

Pin 10 and shank 14 are preferably cylindrical in shape as well as the internal bores 16 and 18. The release button 26 and shaft 28 are also preferably cylindrical in shape. The dimensions of the flanged head 12 are preferably the same as those of an equivalently sized standard clevis pin.

Ball 46 is inserted into the radial hole 22 and held captive either by coining the edges of hole 22 or by undercutting the diameter of hole 22. While only a single ball 46 and its corresponding radial hole 22 is shown, the use of more than one paired ball and radial hole is possible for a more secure locking condition depending on the particular locking requirements.

Ball 46 is inserted into the radial hole 22 and the shaft 28 is then inserted into the bore 18 of the non-flanged end 24 of pin 10. Spring 34 is then inserted over shaft 28 as shaft 28 sticks into the area of bore 16. Release button 26 is then attached over the end of shaft 28 by suitable means. Such attachment of release button 26 to shaft 28 can be by threading, by press fitting, by orbital riveting or by any other suitable attachment means. Release button 26 is preferably sized so that its face 50 does not protrude out past the face 36 of flange 12 so as to reduce accidental operation from impingement with foreign objects. However, it should be noted that in some cases it may actually be desirable to have the release button 26 protrude past face 50 such as in applications where an easier access to operate the release button 26 is deemed more important that the risk of accidental operation from impingements.

Spring 34 pushes against the backside 48 of release button 36 and also pushes against edge 38 of internal flange 20. Shaft 28 is constrained from moving axially along the direction of bore 16 beyond a specified limit by the eventual interference of the axial side 42 of flange 30 impinging against the axial side 40 of internal flange 30.

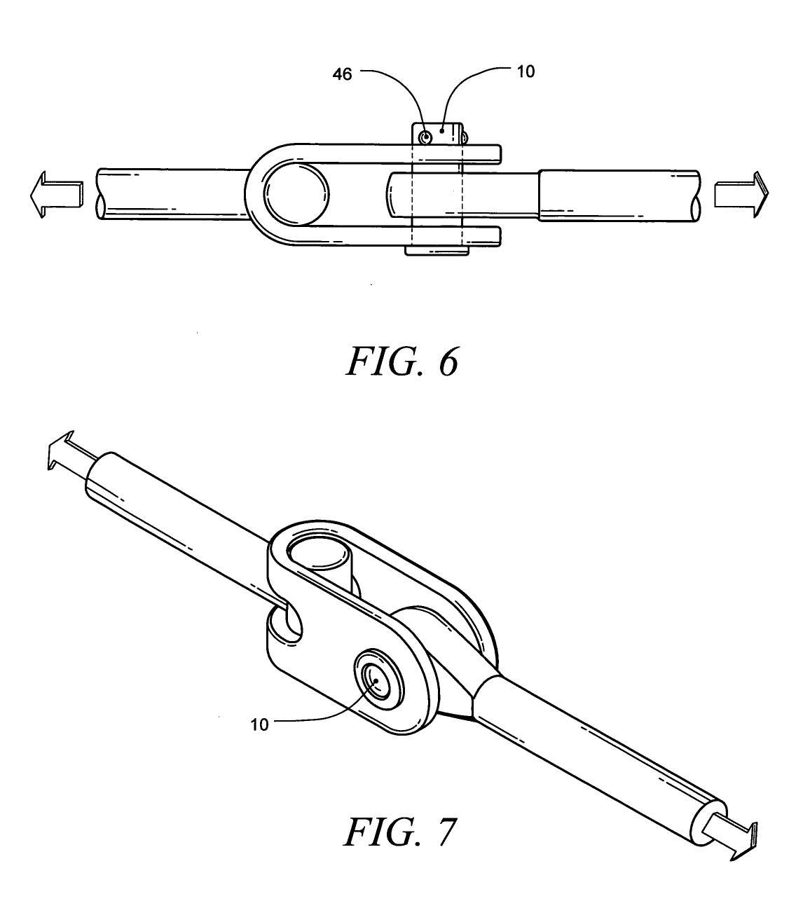

Pushing onto face 50 of release button 26 causes the shank 28 to move axially within the bore 16 of pin 10. The shaft end 32 contains a diameter 52 and a beveled transition 44. Axial movement of shaft end 32 eventually allows the ball 46 to move into the recess 56 caused by the smaller diameter 54 of shaft 18. This new positioning of ball 46 reduces the effective diameter of pin 10 and allows pin 10 to slide axially into or out of a joining member (shown in FIG. 6, 7, the turnbuckle example). The smaller diameter 54 of shaft 18 is sized big enough so that the balls 46 do not completely fall out of holes 22 so as to keep balls 46 from coming out of position or rattling around freely in recess 56. The continued axial movement of shaft 18 by further pushing on face 50 is eventually constrained by either balls 46 impinging against face 58 of flange 30, or by spring 34 being compressed to a point where its individual coils 60 compress against each other thereby reaching a solid spring configuration and restricting further movement of axial shaft 18.

Releasing the force on the face 50 of release button 26 allows the spring 34 to push shaft 28 axially whereas balls 46 roll up the beveled transition 44 and pop back into the radial hole 22. In this configuration the effective diameter of pin 10 is increased thereby restricting the movement of pin 10 to slide axially out of a joined member.

Pin 10 is preferably constructed from stainless steel such as 17-4PH and the ball 46 from a hardened stainless steel such as 440C. The spring 34 is also preferably a stainless steel coil spring. These materials are preferable for a marine environment. However, it should be noted that any other suitable materials could also be implemented in consideration of environment and circumstances of the particular use.

Referring now to FIGS. 8, 9 and 10, the preferred embodiment is shown. The mechanism of this variation is the same, except invention 10 may be released with button 26 or 26A, thus, making the clevis pin releasable from either end of invention 10. In this manner, when invention 10 is used in situations where it might be difficult to gain access to one end of the pin and not the other, invention 10 can still be easily removed by merely pressing either button 26 or 26A whichever is more convenient.

As in the alternative embodiment shown in FIG. 3, ball 46 is inserted into the radial hole 22 and held captive either by coining the edges of hole 22 or by undercutting the diameter of hole 22. Again, while only a single ball 46 and its corresponding radial hole 22 is shown, the use of more than one paired ball and radial hole is possible for a more secure locking condition depending on the particular locking requirements.

Ball 46 is inserted into the radial hole 22 and the shaft 28 is then inserted into the bore 18 of the non-flanged end 24 of pin 10. Spring 34 is then inserted over the shaft 28 as the shaft 28 sticks into the area of bore 16. A second spring 34A is also inserted over shaft 28 on the other side of internal flange 20. Release button 26 is then attached over the end of shaft 28 by suitable means. Such attachment of release button 26 to shaft 28 can be by threading, by press fitting, by orbital riveting or by any other suitable attachment means. Release button 26 is preferably sized so that its face 50 does not protrude out past the face 36 of flange 12 so as to reduce accidental operation from impingement with foreign objects. However, it should be noted that in some cases it may actually be desired to have the release button 26 protrude past the face 50 such in applications where an easier access to operate the release button 26 is deemed more important that the risk of accidental operation from impingements.

Second release button 26A is provided opposite to release button 26. Again, second release button 26A may be protruded or flushed depending on the particular application where invention 10 is being used.

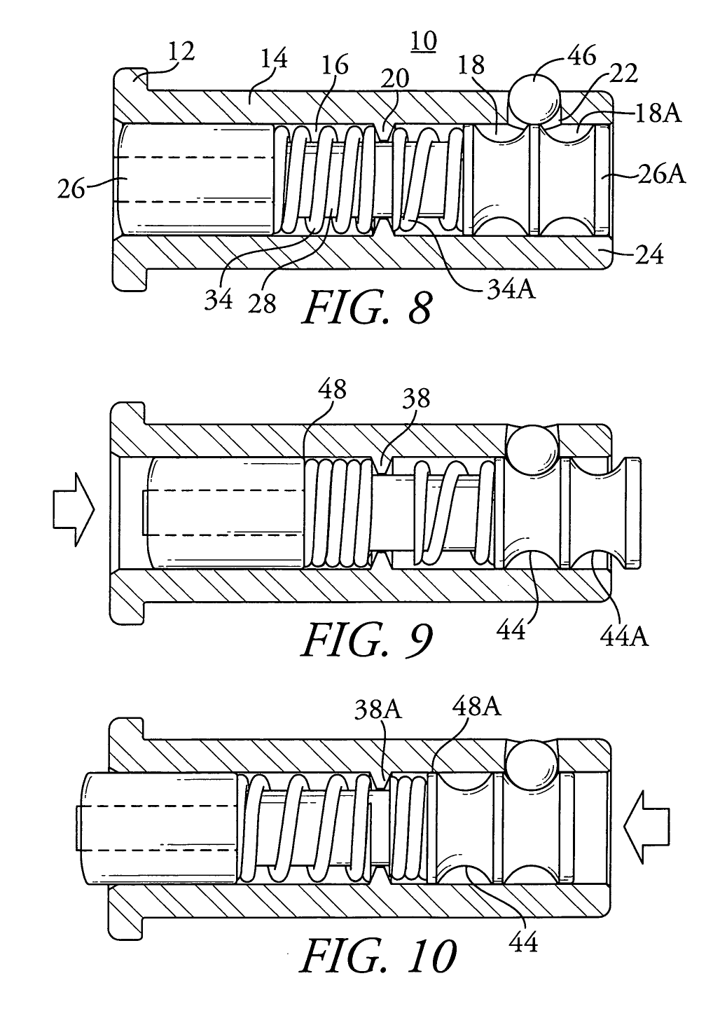

As shown in FIG. 8, spring 34 pushes against the backside 48 of release button 36 and also pushes against the edge 38 of internal flange 20. Similarly, as shown in FIG. 10, spring 34A pushes 48A against edge 38A of internal flange 20. As shown in FIG. 9, shaft 28 is constrained from moving axially along the direction of bore 16 beyond a specified limit by the eventual interference of spring 34 against edge 38 and, in FIG. 10, shaft 28 is constrained from moving axially along the direction of bore 16 beyond a specified limit in the other direction by spring 34A against edge 38A.

As shown in FIG. 9, pushing onto release button 26 causes the shank 28 to move axially within the bore 16 of pin 10 thus releasing ball 46. As shown in FIG. 10, pushing onto release button 26A, causes the shank 28 to move axially in the opposite direction within bore 16 of pin 10, again releasing ball 46. The shaft end 32 contains a diameter 52 and a two recesses 44 and 44A. Axial movement of shaft end 32 eventually allows the ball 46 to move into recess 44 or 44A depending on which release button 26 or 26A is pushed. This new positioning of ball 46 reduces the effective diameter of pin 10 and allows pin 10 to be slide axially into or out of a joining member (shown in FIG. 6, 7, the turnbuckle example). Releasing the force on button 26 or 26A allows the springs to push shaft 28 axially whereas ball 46 returns to the position shown in FIG. 8 thereby restricting the movement of pin 10 to slide axially out of a joined member.

Although the present invention has been described with reference to certain preferred embodiments thereof, other versions are readily apparent to those of ordinary skill in art of the preferred embodiments contained herein.

What is claimed is:

1. A ball-type clevis pin for releasably holding together two parts using a fastening opening in each part such that one part may rotate relative to the other part, said clevis pin comprising:
a hollow shank having a flange end and a ball end, wherein said shank has substantially uniform longitudinal internal and external diameters wherein the external diameter corresponds to the diameter of the fastening openings in each part and said shank having a flanged head at the flange end of said shank, and said flanged head having a diameter wherein the diameter of said flanged head is greater than the external diameter of said shank as well as greater than the diameter of the openings in each part being held together;
a ball-type quick release mechanism having a push button that activates a ball which can release said ball from said locking pin within the openings of said parts when said button is pushed, said mechanism is dimensioned to correspond to the internal diameter of said shank such that said mechanism can fit within said shank with the push button adjacent to the flange end and the ball of said mechanism positioned adjacent to the ball end of said shank.

2. The clevis pin of claim 1 wherein said mechanism further comprises a second push button adjacent to the ball end of said shank which can release said ball when said second push button is activated.

3. The clevis pin of claim 2 wherein said mechanism further comprising two compression type springs such that said pin is in a locked position with the ball extended when both said springs are not compressed and wherein said pin is in a unlocked position when either compression type spring is compressed by its corresponding push button, releasing said ball thus permitting the parts to be released from one another.

4. The clevis pin of claim 3 wherein said first push button of said mechanism does not extend substantially beyond said flanged head at the flange end of said shank.

5. The clevis pin of claim 4 wherein said second push button of said mechanism does not extend substantially beyond the ball end of said shank.

6. The clevis pin of claim 1 wherein said pin has substantially the same dimensions, profile, and resistance to axial direction force as a standard cotter pin type clevis pin.

7. The clevis pin of claim 1 wherein said pin can be substituted interchangeably with a cotter pin/spring ring clevis pin of the same size.
